(19) United States
(12) Patent Application Publication
(10) Pub. No.: US 2013/0189605 A1
(43) Pub. Date: Jul. 25, 2013

(54) CERIA-BASED COMPOSITION, CERIA-BASED COMPOSITE ELECTROLYTE POWDER, METHOD FOR SINTERING THE SAME AND SINTERED BODY MADE THEREOF

(71) Applicant: Korea Institute of Science and Technology, Seoul (KR)

(72) Inventors: Shin Ae SONG, Seoul (KR); Sung Pil YOON, Gyeonggi-do (KR); Seong Ahn HONG, Seoul (KR); Tae Hoon LIM, Seoul (KR); Jong Hee HAN, Seoul (KR); In Hwan OH, Seoul (KR); Suk Woo NAM, Seoul (KR); Hyoung Juhn KIM, Gyeonggi-do (KR); Eun Ae CHO, Seoul (KR); Jong Hyun JANG, Seoul (KR); Dirk HENKENSMEIER, Seoul (KR); Thieu CAM-ANH, Ho Chi Minh City (VN)

(73) Assignee: KOREA INSTITUTE OF SCIENCE AND TECHNOLOGY, Seoul (KR)

(21) Appl. No.: 13/744,527

(22) Filed: Jan. 18, 2013

(30) Foreign Application Priority Data
Jan. 20, 2012 (KR) 10-2012-0006875

(51) Int. Cl. H01M 8/12

(52) U.S. Cl. CPC H01M 8/126
USPC 429/496; 429/495

(57) ABSTRACT

Provided are a ceria-based composition including ceria or metal-doped ceria, lithium salt, and optionally, bismuth oxide, ceria-based composite electrolyte powder, and a sintering method and sintered body using the same. Particularly, the lithium salt is present in an amount more than 0 wt % and equal to or less than 5 wt %, and bismuth oxide is present in an amount more than 0 wt % and equal to or less than 10 wt %. It is possible to reduce sintering temperature by adding a low-melting point and/or volatile compound to a ceria-based material. In this manner, it is possible to ensure a high composite sintering density, for example, of 95% or more even at a temperature, for example, of 1000° C. or lower, which is significantly lower than the conventional sintering temperature of 1500° C. in the case of a ceria-based material alone.

### CROSS-REFERENCE TO RELATED APPLICATION

This application claims priority to Korean Patent Application No. 10-2012-0006875, filed on Jan. 20, 2012, and all the benefits accruing therefrom under 35 U.S.C. §119, the contents of which in its entirety are herein incorporated by reference.

### BACKGROUND

1. Field

The present disclosure relates to a ceria-based composition, ceria-based composite electrolyte powder, and a sintering method and sintered body using the same. More particularly, the present disclosure relates to a ceria-based composition which allows ceria-based electrolyte for use in high temperature sensors, solid oxide fuel cells, or the like to be sintered at low temperature, ceria-based composite electrolyte powder, and a sintering method and sintered body using the same.

2. Description of the Related Art

Electrolyte for use in sensors or fuel cells is an ion conductor through which ions generated at one electrode move toward the other electrode. Therefore, it is required for such electrolyte to have high ion conductivity and have no electron conductivity. In addition, when used in fuel cells, electrolyte is required to be so dense that a so-called cross-over phenomenon, in which anode gas is mixed with cathode gas, may be prevented, and to be stable structurally and chemically at high temperature and under both oxidative atmosphere and reductive atmosphere.

As a material satisfying the above requirements relatively well, there is yttria stabilized zirconia (YSZ). Yttria stabilized zirconia has excellent mechanical strength and shows stability and reproducibility as electrolyte for solid oxide fuel cells, and thus is most widely used now.

However, sensors or solid oxide fuel cells using yttria stabilized zirconia electrolyte have difficulty in manufacturing large-area cells and require high manufacturing cost due to a high sintering temperature of about 1400° C. or higher.

Meanwhile, recently, active studies have been conducted about electrolyte materials having high oxygen ion conductivity to provide high-quality solid oxide fuel cells. For example, many studies have been conducted about doped oxidized bismuth (Bi₂O₃), perovskite structured compounds, such as lanthanum gallate (LaGaO₃) or barium cerate (BaCeO₃), doped ceria (CeO₂), or the like. Particularly, among them, ceria has significantly high ion conductivity and relatively excellent mechanical properties, and thus is given many attentions as a prominent electrolyte substitute material.

However, ceria-based electrolyte requires a higher sintering temperature (at least about 1500° C.) as compared to the known yttria stabilized zirconia electrolyte. Moreover, since ceria itself is a hardly sinterable material, it has difficulty in densification and scaling-up even it is sintered. This makes it difficult to commercialize ceria-based electrolyte.

Low-temperature sintering processes applicable to such electrolyte include chemical vapor deposition (CVD), electrochemical vapor deposition (EVD), plasma sputtering, electrophoretic deposition (EPD), or the like. However, such processes require expensive systems or operations, and thus are not suitable for scaling-up and cost saving.

Q. Zhu et al. discloses that very fine particles with a size of 9 nm are obtained by using a hydrothermal process to reduce the sintering temperature of yttria stabilized zirconia (Non-patent Document 1). Since a decrease in particle size results in an increase in surface energy, sintering of particles may be carried out at a temperature significantly lower than the conventional sintering temperature of bulk particles. However, according to the study of the present inventors, the above method requires high cost to reduce the size of particles into several nanometers, resulting in poor cost efficiency.

Zhang et al. discloses that incorporation of 1% copper oxide or cobalt oxide to samarium-doped ceria reduces the sintering temperature from 1400° C. or more to about 1000° C. (Non-patent Document 2). However, according to the study of the present inventors, the above method has its limitations in that it is not possible to reduce the sintering temperature to 1000° C. or lower.

V. Gil et al. have conducted an attempt by adding bismuth oxide to gadolinium-doped ceria to reduce the sintering temperature (Non-patent Document 3). However, according to the study of the present inventors, the above method has its limitations in that the sintering temperature is reduced at most to 1200° C.

### REFERENCES OF THE RELATED ART

### Non-Patent Document

(Non-patent Document 1) Solid State Ionics 176, 889-894, 2005
(Non-patent Document 2) Journal of Power Sources, 162, 480-485, 2006
(Non-patent Document 3) Solid State Ionics 178, 359-365, 2007

### SUMMARY

The present inventors have conducted many studies about the most suitable method for preparing a ceria-based material, particularly ceria-based electrolyte requiring high sintering temperature to accomplish scaling-up and coat saving. More particularly, a low-temperature sintering method, for example, an in-situ sintering method in fuel cells (a method of co-sintering electrolyte at a range of fuel cell driving temperatures) is studied intensively to allow sintering with densification and scaling-up. As a result, we have found that adding a specific material to a ceria (CeO₂)-based material allows significant reduction of sintering temperature, for example, to 1000° C. or lower. The present disclosure is based on this finding.

The present disclosure is directed to providing a ceria-based composition, which reduces sintering temperature, for example, to a low-temperature of 1000° C. or lower and allows sintering with densification and scaling-up even at such a low temperature. The present disclosure is also directed to providing ceria-based composite electrolyte powder, and a sintering method and sintered body using the ceria-based composition.

In one aspect, there is provided a ceria-based composition, including: ceria or metal-doped ceria; and a lithium salt. Herein, the lithium salt may be present in an amount more than 0 wt % and less than 50 wt % based on the total weight of the composition.

According to an embodiment, the lithium salt may be lithium carbonate (Li₂CO₃), lithium hydroxide (Li0H) or lithium nitrate (LiNO₃), particularly lithium carbonate.

According to another embodiment, the lithium salt such as lithium carbonate may be present in an amount more than 0 wt % and equal to or less than 5 wt % based on the total weight of the ceria-based composition.

According to still another embodiment, the lithium salt such as lithium carbonate may be present in an amount more than 0 wt % and equal to or less than 1 wt % based on the total weight of the ceria-based composition.

According to still another embodiment, the lithium salt such as lithium carbonate may be present in an amount of 0.5 wt % or 1 wt % based on the total weight of the ceria-based composition.

According to still another embodiment, the metal in the metal-doped ceria may be samarium (Sm), gadolinium (Gd), lanthanum (La), zirconium (Zr), yttrium (Y), ytterbium (Yb), erbium (Er), praseodymium (Pr) or neodymium (Nd).

According to still another embodiment, the ceria-based composition may further include bismuth oxide. The combined weight of the lithium salt and bismuth oxide may be more than 0 wt % and equal to or less than 50 wt % based on the total weight of the ceria-based composition.

According to still another embodiment, bismuth oxide may be present in an amount more than 0 wt % and equal to or less than 10 wt % based on the total weight of the ceria-based composition.

According to still another embodiment, bismuth oxide may be present in an amount more than 0 wt % and equal to or less than 5 wt % based on the total weight of the ceria-based composition.

According to still another embodiment, bismuth oxide may be present in an amount more than 0 wt % and equal to or less than 3 wt % based on the total weight of the ceria-based composition.

According to still another embodiment, the ceria-based composition may include more than 0 wt % and equal to or less than 5 wt %, particularly more than 0 wt % and equal to or less than 1 wt % of lithium carbonate, and more than 0 wt % and equal to or less than 10 wt %, particularly more than 0 wt % and equal to or less than 5 wt %, and more particularly more than 0 wt % and equal to or less than 3 wt % of bismuth oxide.

According to still another embodiment, the ceria-based composition may include more than 0 wt % and equal to or less than 1 wt % of lithium carbonate, and more than 0 wt % and equal to or less than 3 wt % of bismuth oxide.

According to yet another embodiment, the ceria-based composition may include 0.5 wt % or 1 wt % of lithium carbonate and 3 wt % of bismuth oxide.

In another aspect, there is provided powder obtained by calcination of the ceria-based composition, or a sintered body obtained by sintering the ceria-based composition.

According to an embodiment, the sintered body may be used as electrolyte.

In still another aspect, there is provided ceria-based composite electrolyte powder, which is a calcined body of the ceria-based composition including ceria or metal-doped ceria and a lithium salt. Herein, the lithium salt may be present in an amount more than 0 wt % and less than 50 wt % based on the total weight of the ceria-based composition, as described above.

According to an embodiment, the lithium salt may be lithium carbonate (Li₂CO₃), lithium hydroxide (LION) or lithium nitrate (LiNO₃), particularly lithium carbonate.

According to another embodiment, the lithium salt such as lithium carbonate may be present in an amount more than 0 wt % and equal to or less than 5 wt % based on the total weight of the ceria-based composition.

According to still another embodiment, the lithium salt such as lithium carbonate may be present in an amount more than 0 wt % and equal to or less than 1 wt % based on the total weight of the ceria-based composition.

According to still another embodiment, the lithium salt such as lithium carbonate may be present in an amount of 0.5 wt % or 1 wt % based on the total weight of the ceria-based composition.

According to still another embodiment, the metal in the metal-doped ceria may be samarium (Sm), gadolinium (Gd), lanthanum (La), zirconium (Zr), yttrium (Y), ytterbium (Yb), erbium (Er), praseodymium (Pr) or neodymium (Nd).

According to still another embodiment, the ceria-based composition may further include bismuth oxide. The combined weight of the lithium salt and bismuth oxide may be more than 0 wt % and less than 50 wt % based on the total weight of the ceria-based composition.

According to still another embodiment, bismuth oxide may be present in an amount more than 0 wt % and equal to or less than 10 wt % based on the total weight of the ceria-based composition.

According to still another embodiment, bismuth oxide may be present in an amount more than 0 wt % and equal to or less than 5 wt % based on the total weight of the ceria-based composition.

According to still another embodiment, bismuth oxide may be present in an amount more than 0 wt % and equal to or less than 3 wt % based on the total weight of the ceria-based composition.

According to still another embodiment, bismuth oxide may be present in an amount of 3 wt % based on the total weight of the ceria-based composition.

According to still another embodiment, the ceria-based composition may include more than 0 wt % and equal to or less than 5 wt %, particularly more than 0 wt % and equal to or less than 1 wt % of lithium carbonate, and more than 0 wt % and equal to or less than 10 wt %, particularly more than 0 wt % and equal to or less than 5 wt %, and more particularly more than 0 wt % and equal to or less than 3 wt % of bismuth oxide.

According to still another embodiment, the ceria-based composition may include more than 0 wt % and equal to or less than 1 wt % of lithium carbonate, and more than 0 wt % and equal to or less than 3 wt % of bismuth oxide.

According to yet another embodiment, the ceria-based composition may include 0.5 wt % or 1 wt % of lithium carbonate and 3 wt % of bismuth oxide.

In still another aspect, there is provided a sintered body of the composite electrolyte powder.

In still another aspect, there is provided a sintering method, including subjecting the ceria-based composition to calcination to provide powder and then sintering the powder, or sintering the ceria-based composition as it is without calcination.

According to an embodiment, the composite electrolyte powder may be subjected to ball milling.

According to another embodiment, the powder or composition is charged to a fuel cell without additional sintering, and then is sintered during the operation of the fuel cell.

According to still another embodiment, the sintering may be carried out at a temperature of 800-1000° C.

In yet another aspect, there is provided sintered electrolyte obtained by the above-mentioned method.

According to the present disclosure, it is possible to reduce sintering temperature by adding, to a ceria-based material, a lithium salt, such as lithium carbonate as a low-melting point and/or volatile compound. In this manner, it is possible to accomplish sintering at a temperature, for example, of 1000° C. or lower, which is significantly lower than the conventional sintering temperature of 1500° C. in the case of a ceria-based material alone. It is also possible to ensure a high composite sintering density, for example, of 95% or more.

As a result, the ceria-based composition and composite electrolyte powder are applicable to densification and scaling-up through a low-temperature sintering process, such as low-temperature in situ sintering in a fuel cell. Therefore, it is possible to contribute to commercialization of ceria-based electrolyte.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1a and FIG. 1b are scanning electron microscopy (SEM) images of Example 1 (composite powder including samarium-doped ceria mixed with bismuth oxide and lithium carbonate; bismuth oxide content: 3 wt % in the composition, lithium carbonate content: 1 wt % in the composition), after it is sintered at 1000° C. for 2 hours, wherein FIG. 1a is the SEM image of the surface and FIG. 1b is the SEM image of a broken surface;

FIG. 2 is an SEM image of the surface of Comparative Example using samarium-doped ceria alone, after it is sintered at 1500° C. for 2 hours;

FIG. 3 is a graph illustrating variations in porosity as a function of sintering temperature in the sintered bodies obtained by using samarium-doped ceria, 1% of lithium carbonate and a variable amount of bismuth oxide according to Test Example 2, wherein porosity has the opposite concept to sintering density and means 100%-sintering density;

FIG. 4 is a graph illustrating the results of measurement of electroconductivity of the sintered body obtained by sintering the powder of Comparative Example at 1500° C. for 2 hours (shown as ‘▪’ in the graph), and that of the sintered body obtained by sintering the powder of Example 1 (composite powder including samarium-doped ceria mixed with bismuth oxide and lithium carbonate; bismuth oxide content: 3 wt % in the composition, lithium carbonate content: 1 wt % in the composition) at 800° C. for 2 hours (shown as ‘▪’ in the graph), wherein X axis represents 100/temperature (unit: K⁻¹), and Y axis represents log of conductivity (unit: S/cm); and

FIG. 5 is a graph illustrating variations in porosity at a sintering temperature of 1000° C. in the sintered bodies obtained by using samarium-doped ceria and a variable amount of lithium carbonate according to Test Example 4, wherein porosity has the opposite concept sintering density and means 100%-sintering density.

### DETAILED DESCRIPTION

As used herein, the term teria-based' means that the corresponding composition includes ceria or metal-doped ceria as a main ingredient, i.e., includes ceria or metal-doped ceria in an amount of at least 50 wt %.

As the most suitable sintering method of a ceria-based material, i.e., ceria or metal-doped ceria for the purpose of scaling-up and cost saving, there is a low-temperature sintering method, such as in-situ sintering in a fuel cell (co-sintering of electrolyte in a range of driving temperatures of a fuel cell).

However, in the case of such in-situ sintering, it is required that sintering temperature of each component in a fuel cell, i.e., an anode, electrolyte or a cathode is set within a temperature range against which a separator material resists. Thus, a significantly low co-sintering temperature is required. For example, when a conventional metal material is used as a separator, sintering may be carried out at 800° C. or lower for less than 2 hours. When an Inconel-series high-temperature metal material is used as a separator, sintering may be carried out suitably at 1000° C. or lower for less than 2 hours.

Some embodiments of the present disclosure are directed to providing a ceria-based composition which allows sintering even at low sintering temperature and enables densification and scaling-up, ceria-based composite electrolyte powder, and a sintering method and sintered body using the same.

In other words, a lithium salt having a low melting point and/or volatility may be mixed with ceria or metal-doped ceria, or bismuth oxide having a low melting point may be further mixed therewith to reduce sintering temperature and to allow densification and scaling-up of a ceria-based material even at a low temperature (e.g. 1000° C. or lower).

Therefore, according to an embodiment, there is provided a ceria-based composition or composite electrolyte powder including ceria or metal-doped ceria, and a lithium salt. The composite electrolyte powder is one obtained by calcination of the ceria-based composition. Herein, the ceria-based composition is based on ceria or metal-doped ceria, and thus includes the same in an amount of at least 50 wt %. Accordingly, the lithium salt may be present in an amount more than 0 wt % and less than 50 wt % based on the total weight of the composition.

According to another embodiment, the ceria-based composition may further include bismuth oxide. As described above, since ceria or metal-doped ceria is a main ingredient, the composition includes the same in an amount of at least 50 wt %. Accordingly, the combined weight of the lithium salt and bismuth oxide may be more than 0 wt % and less than 50 wt % based on the total weight of the composition.

According to still another embodiment, particular examples of the lithium salt include lithium carbonate (Li₂CO₃), lithium hydroxide (LiOH) or lithium nitrate (LiNO₃), particularly lithium carbonate.

According to still another embodiment, the lithium salt, such as lithium carbonate, may be present in an amount more than 0 wt % and equal to or less than 5 wt %, particularly more than 0 wt % and equal to or less than 1 wt % based on the total weight of the ceria-based composition. As a non-limiting example, the lithium salt content may be 1 wt %. As another non-limiting example, the lithium salt content may be 0.5 wt %. When the lithium salt content is 0.5 wt %, porosity may be decreased significantly as compared to the composition having a lithium salt content of 1 wt %.

When the lithium salt, such as lithium carbonate, is present in an amount more than 0 wt % and even in a small amount, it is possible to reduce sintering temperature and to provide densified electrolyte. Particularly, when the lithium content is equal to or less than 1 wt %, a high densification degree may be obtained while reducing sintering temperature. However, when the lithium salt, such as lithium carbonate, is present in an amount more than 5 wt %, gas (e.g. carbon dioxide in the case of lithium carbonate) may be generated at high temperature during sintering, and the gas may cause pore formation, thereby causing an undesired drop in densification degree and making it difficult to obtain a desired sintering density.

There is no particular limitation in metal-doped ceria. Particular examples of metal dopants include samarium (Sm), gadolinium (Gd), lanthanum (La), zirconium (Zr), yttrium (Y), ytterbium (Yb), erbium (Er), praseodymium (Pr) or neodymium (Nd).

According to still another embodiment, bismuth oxide may be present in an amount more than 0 wt % and equal to or less than 10 wt %, particularly more than 0 wt % and equal to or less than 5 wt %, and more particularly more than 0 wt % and equal to or less than 3 wt % based on the total weight of the ceria-based composition in order to obtain a desired sintering density at low temperature. In other words, in order to obtain a desired sintering density (95% or higher) even at 1000° C. or lower (particularly at 800° C.), bismuth oxide may be added in an amount more than 0 wt % and equal to or less than 5 wt %, particularly more than 0 wt % and equal to or less than 3 wt %. When bismuth oxide is present in an amount more than 3 wt %, sintering density is lowered at 800° C., 900° C. and 1000° C. When bismuth oxide is present in an amount more than 5 wt %, sintering density is lowered at 800° C. and 900° C. When bismuth oxide is present in an amount more than 10 wt %, sintering density is lowered at 800° C., 900° C. and 1000° C.

According to still another embodiment, the ceria-based composition may be calcined (e.g. at 300° C.-800° C.) to provide powder, which, in turn, is sintered again. However, the ceria-based composition may be sintered directly without calcination. The sintered body obtained in the above manners may be useful as electrolyte.

Meanwhile, the ceria-based composition or ceria-based composite electrolyte powder may be charged to a solid oxide fuel cell or the like without additional sintering, and then subjected to low-temperature in-situ sintering, for example, at a temperature of 1000° C. or lower, such as a temperature of 800° C.-1000° C. during the operation of the fuel cell. Even when the composition or powder is subjected to low-temperature sintering in the above-mentioned manner, it is possible to ensure a sintering density of 95% or higher.

The examples and comparative examples now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art.

Samarium-doped ceria (SDC powder (Sm_{0.2}Ce_{0.8}O₂, available from Praxair Co., USA) as metal-doped ceria is mixed with lithium carbonate (Li₂CO₃ powder, available from Daejung Chemicals & Metals Co., Ltd., Korea) and/or bismuth oxide (Bi₂O₃, available from Praxair Co., USA) to provide a composition. Then, the composition is mixed by dry ball milling for 2 hours, and subjected to calcination at 700° C. for 3 hours to obtain the composites of the following Comparative Example and Examples.

Comparative Example is samarium-doped ceria powder alone. Example 1 is composite electrolyte powder including samarium-doped ceria mixed with lithium carbonate and bismuth oxide; lithium carbonate content: 1 wt % in the composition, bismuth oxide content: 3 wt % in the composition). Example 2 is composite electrolyte powder including samarium-doped ceria mixed with lithium carbonate and bismuth oxide; lithium carbonate content: 1 wt % in the composition, bismuth oxide content: 5 wt % in the composition).

Example 3 is composite electrolyte powder including samarium-doped ceria mixed with lithium carbonate and bismuth oxide; lithium carbonate content: 1 wt % in the composition, bismuth oxide content: 10 wt % in the composition).

Example 4 is composite electrolyte powder including samarium-doped ceria mixed with lithium carbonate and bismuth oxide; lithium carbonate content: 1 wt % in the composition, bismuth oxide content: 20 wt % in the composition).

Example 5 is composite electrolyte powder including samarium-doped ceria mixed with lithium carbonate; lithium carbonate content: 0.5 wt % in the composition).

Example 6 is composite electrolyte powder including samarium-doped ceria mixed with lithium carbonate; lithium carbonate content: 1 wt % in the composition).

Example 7 is composite electrolyte powder including samarium-doped ceria mixed with lithium carbonate; lithium carbonate content: 5 wt % in the composition).

Example 8 is composite electrolyte powder including samarium-doped ceria mixed with lithium carbonate; lithium carbonate content: 10 wt % in the composition).

Example 9 is composite electrolyte powder including samarium-doped ceria mixed with lithium carbonate; lithium carbonate content: 20 wt % in the composition).

### TEST EXAMPLE 1

Each of the powder of Comparative Example and powder of Example 1 (composite electrolyte powder including samarium-doped ceria mixed with lithium carbonate and bismuth oxide; lithium carbonate content: 1 wt % in the composition, bismuth oxide content: 3 wt % in the composition) is introduced into a bar-like mold with a size of 1 cm×cm×cm, and subjected to uniaxial pressurized molding, followed by sintering, to provide a sample for determination of electroconductivity and sintering density.

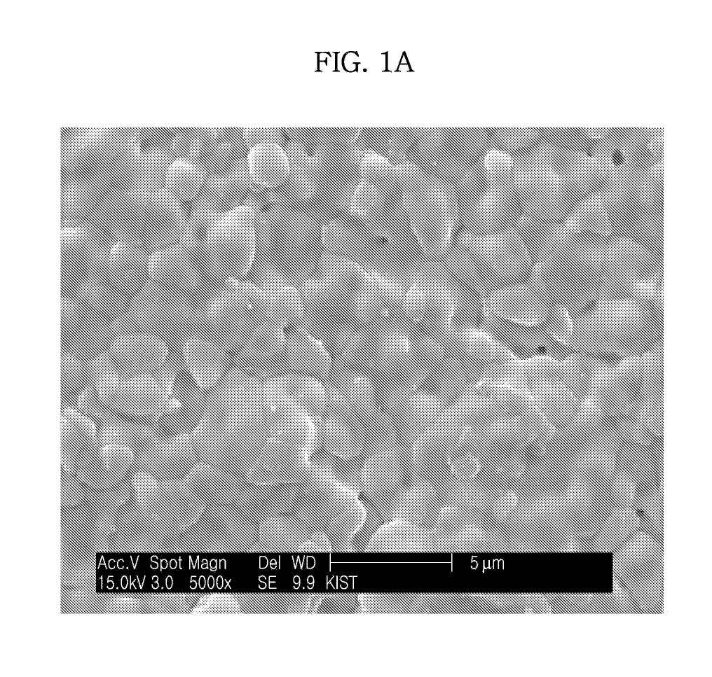

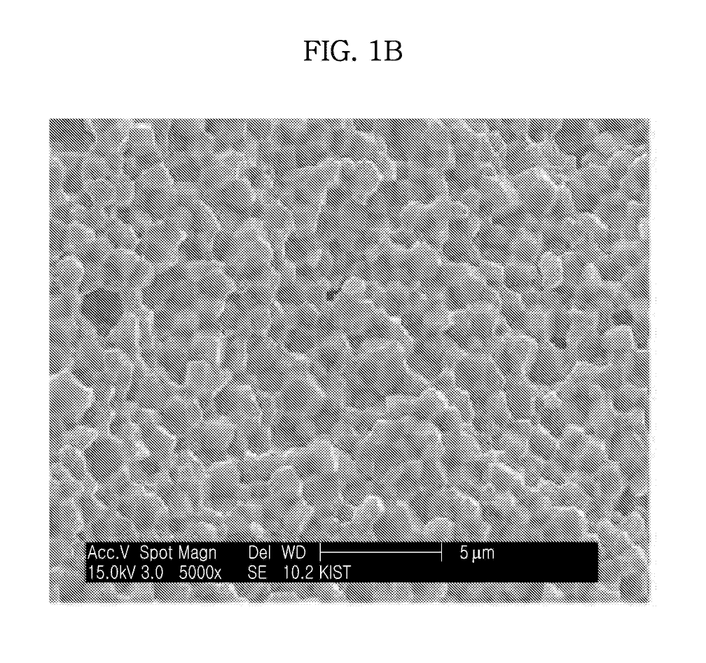

FIG. 1a and FIG. 1b are scanning electron microscopy (SEM) images of Example 1 (composite powder including samarium-doped ceria mixed with bismuth oxide and lithium carbonate; lithium carbonate content: 1 wt % in the composition, bismuth oxide content: 3 wt % in the composition), after it is sintered at 1000° C. for 2 hours, wherein FIG. 1a is the SEM image of the surface and FIG. 1b is the SEM image of a broken surface.

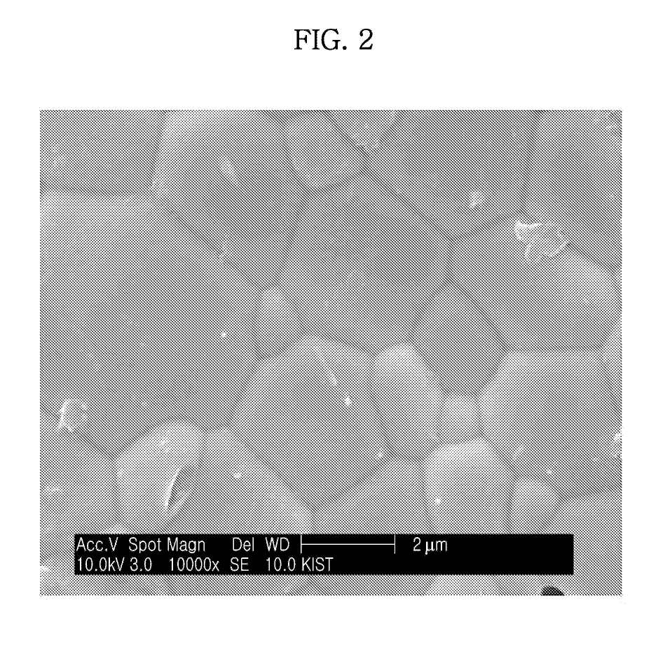

FIG. 2 is an SEM image of the surface of Comparative Example (samarium-doped ceria alone), after it is sintered at 1500° C. for 2 hours.

As shown in FIG. 2, it can be seen from the surface image of the powder of Comparative Example after it is sintered at 1500° C. for 2 hours that the powder is sintered to a certain degree but the sintering temperature is as high as 1500° C. For reference, it is shown that the porosity measured by the Archimedes method is 95% of the theoretical density.

On the contrary, as can be seen from FIG. 1, Example 1 provides a very dense surface even at a low temperature of 1000° C. after it is sintered at 1000° C. for 2 hours, and ensures a porosity of at least 98% of the theoretical density.

### TEST EXAMPLE 2

Each of Example 1 (composite powder including samarium-doped ceria mixed with lithium carbonate and bismuth oxide; bismuth oxide content: 3 wt % in the composition, lithium carbonate content: 1 wt % in the composition); Example 2 (composite powder including samarium-doped ceria mixed with lithium carbonate and bismuth oxide; bismuth oxide content: 5 wt % in the composition, lithium carbonate content: 1 wt % in the composition); Example 3 (composite powder including samarium-doped ceria mixed with lithium carbonate and bismuth oxide; bismuth oxide content: 10 wt % in the composition, lithium carbonate content: 1 wt % in the composition); and Example 4 (composite powder including samarium-doped ceria mixed with lithium carbonate and bismuth oxide; bismuth oxide content: 20 wt % in the composition, lithium carbonate content: 1 wt % in the composition) is subjected to ball milling to provide different types of composite powder. Each composite powder is introduced into a bar-like mold with a size of 1 cm×cm×cm, and subjected to uniaxial pressurized molding, followed by sintering at 800° C., 900° C. or 1000° C. for 2 hours, to provide samples for determination of electroconductivity and sintering density.

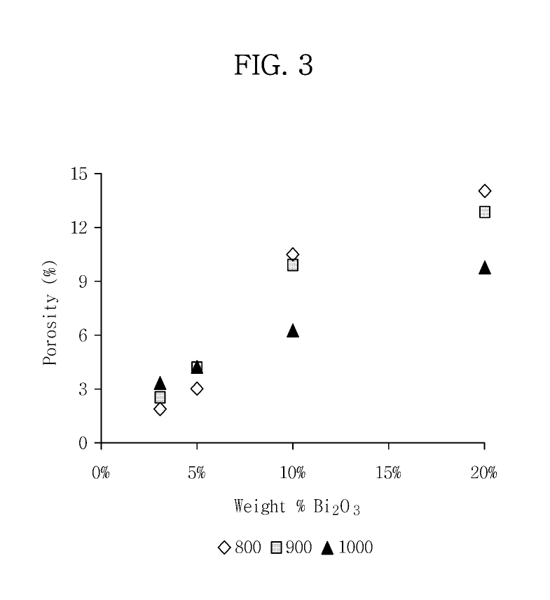

FIG. 3 is a graph illustrating the sintering density determined after each powder of Example 1, Example 2, Example 3 and Example 4 at 800° C., 900° C. or 1000° C. Herein, porosity has the opposite concept to sintering density and means 100%-sintering density. As can be seen from FIG. 3, when Example 1 (composite powder including samarium-doped ceria mixed with lithium carbonate and bismuth oxide; bismuth oxide content: 3 wt % in the composition, lithium carbonate content: 1 wt % in the composition) is subjected to sintering, it is possible to obtain a very dense electrolyte having a sintering density of about 98% even at a sintering temperature of 800° C. This demonstrates that Example 1 enables sintering at a significantly lower temperature as compared to 1500° C. according to the related art. When the composition of Example 3 (samarium-doped ceria to which 1 wt % of lithium carbonate and 10 wt % of bismuth oxide are added) is used, it is possible to obtain a sintered body having a density of about 94% even at 1000° C. Therefore, co-addition of lithium carbonate with bismuth oxide reduces the sintering temperature from 1500° C. (conventional ceria) to 1000° C. or lower.

### TEST EXAMPLE 3

Each sample obtained from the powder of Comparative Example and powder of Example 1 is determined for electroconductivity.

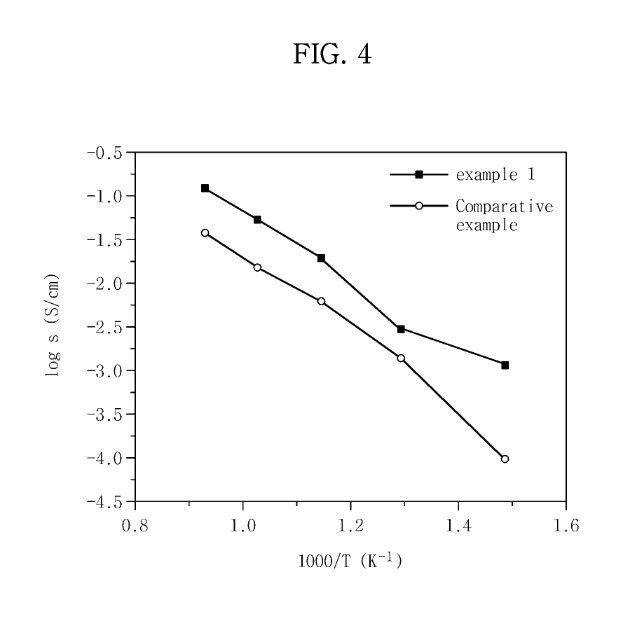

FIG. 4 is a graph illustrating the results of measurement of electroconductivity of the sintered bodies obtained by sintering the powder of Comparative Example at 1500° C. for 2 hours (shown as ‘∘’ in the graph), and that of the sintered body obtained by sintering the powder of Example 1 (composite powder including samarium-doped ceria mixed with bismuth oxide and lithium carbonate; bismuth oxide content: 3 wt % in the composition, lithium carbonate content: 1 wt % in the composition) at 800° C. for 2 hours (shown as in the graph), wherein X axis represents 100/temperature (unit: K⁻¹), and Y axis represents log of conductivity (unit: S/cm).

As can be seen from FIG. 4, the sample of Example 1 provides a higher electroconductivity value as compared to Comparative Example over the whole temperature range (600-1000° C.). It is thought that the powder of Comparative Example sintered at 1500° C. is not densified, and thus provides a relatively low electroconductivity. On the contrary, even when Example 1 is sintered at a low temperature of 800° C., there is no loss of oxygen ions caused by low sintering density. Thus, it can be seen that Example 1 is suitable for an electrolyte substitute applicable to in-situ sintering in a high-temperature fuel cell.

### TEST EXAMPLE 4

Each composite electrolyte powder of Examples 5-9 is sintered at 1000° C. for 2 hours, and determined for sintering density.

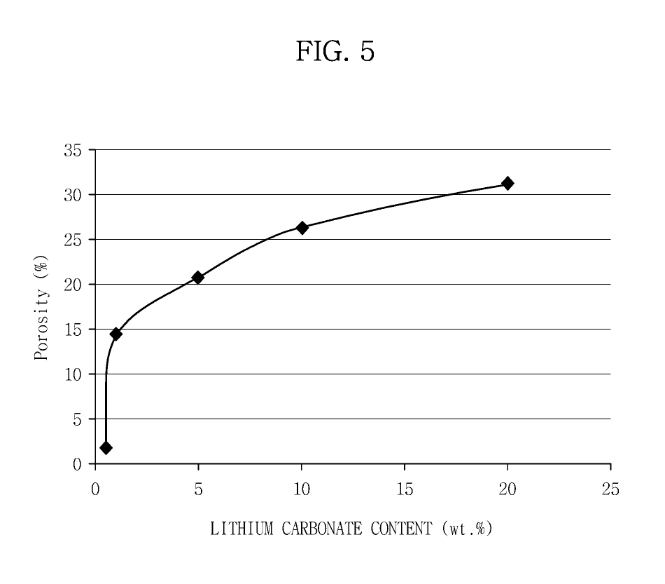

FIG. 5 is a graph illustrating variations in porosity at a sintering temperature of 1000° C. in each sintered body obtained by using the composite electrolyte powder of Examples 5-9 including samarium-doped ceria and a variable amount of lithium carbonate. Herein porosity has the opposite concept to sintering density and means 100%-sintering density

As shown in FIG. 5, addition of lithium carbonate to ceria reduces sintering temperature to 1000° C. It can be seen from the results of porosity that lithium carbonate may be added suitably in an amount of 5 wt % or less, particularly 1 wt % or less (particularly, for example, 0.5 wt %) based on the weight of the composition.

While the exemplary embodiments have been shown and described, it will be understood by those skilled in the art that various changes in form and details may be made thereto without departing from the spirit and scope of the present disclosure as defined by the appended claims.

What is claimed is:

1. A ceria-based composition, comprising: ceria or metal-doped ceria; and a lithium salt, wherein the lithium salt is present in an amount more than 0 wt % and less than 50 wt % based on the total weight of the composition.

2. The ceria-based composition according to claim 1, wherein the lithium salt is lithium carbonate, lithium hydroxide or lithium nitrate

3. The ceria-based composition according to claim 2, wherein the lithium salt is lithium carbonate.

4. The ceria-based composition according to claim 3, wherein lithium carbonate is present in an amount more than 0 wt % and equal to or less than 5 wt % based on the total weight of the ceria-based composition.

5. The ceria-based composition according to claim 4, wherein lithium carbonate is present in an amount more than 0 wt % and equal to or less than 1 wt % based on the total weight of the ceria-based composition.

6. The ceria-based composition according to claim 5, wherein lithium carbonate is present in an amount of 0.5 wt % or 1 wt % based on the total weight of the ceria-based composition.

7. The ceria-based composition according to claim 1, wherein the metal in the metal-doped ceria is samarium (Sm), gadolinium (Gd), lanthanum (La), zirconium (Zr), yttrium (Y), ytterbium (Yb), erbium (Er), praseodymium (Pr) or neodymium (Nd).

8. The ceria-based composition according to claim 1, which further comprises bismuth oxide.

9. The ceria-based composition according to claim 8, wherein bismuth oxide is present in an amount more than 0 wt % and equal to or less than 10 wt % based on the total weight of the ceria-based composition.

10. The ceria-based composition according to claim 9, wherein bismuth oxide is present in an amount more than 0 wt % and equal to or less than 5 wt % based on the total weight of the ceria-based composition.

11. The ceria-based composition according to claim 10, wherein bismuth oxide is present in an amount more than 0 wt % and equal to or less than 3 wt % based on the total weight of the ceria-based composition.

12. The ceria-based composition according to claim 11, wherein bismuth oxide is present in an amount of 3 wt % based on the total weight of the ceria-based composition.

13. A sintered body of a ceria-based composition comprising ceria or metal-doped ceria, a lithium carbonate, and bismuth oxide, wherein the ceria-based composition comprises more than 0 wt % and equal to or less than 5 wt % of lithium carbonate, and more than 0 wt % and equal to or less than 10 wt % of bismuth oxide.

14. The sintered body according to claim 13, wherein the ceria-based composition comprises more than 0 wt % and equal to or less than 1 wt % of lithium carbonate, and more than 0 wt % and equal to or less than 3 wt % of bismuth oxide.

15. Ceria-based composite electrolyte powder, which is a calcined body of a ceria-based composition comprising ceria or metal-doped ceria, and a lithium salt, wherein the lithium salt is present in an amount more than 0 wt % and less than 50 wt % based on the total weight of the composition.

16. The ceria-based composite electrolyte powder according to claim 15, wherein the lithium salt is lithium carbonate, lithium hydroxide or lithium nitrate.

17. The ceria-based composite electrolyte powder according to claim 16, wherein the lithium salt is lithium carbonate.

18. The ceria-based composite electrolyte powder according to claim 17, wherein lithium carbonate is present in an amount more than 0 wt % and equal to or less than 5 wt % based on the total weight of the ceria-based composition.

19. The ceria-based composite electrolyte powder according to claim 18, wherein lithium carbonate is present in an amount more than 0 wt % and equal to or less than 1 wt % based on the total weight of the ceria-based composition.

20. The ceria-based composite electrolyte powder according to claim 19, wherein lithium carbonate is present in an amount of 0.5 wt % or 1 wt % based on the total weight of the ceria-based composition.

21. The ceria-based composite electrolyte powder according to claim 15, wherein the metal in the metal-doped ceria is samarium (Sm), gadolinium (Gd), lanthanum (La), zirconium (Zr), yttrium (Y), ytterbium (Yb), erbium (Er), praseodymium (Pr) or neodymium (Nd).

22. The ceria-based composite electrolyte powder according to claim 15, wherein the ceria-based composition further comprises bismuth oxide.

23. The ceria-based composite electrolyte powder according to claim 22, wherein bismuth oxide is present in an amount more than 0 wt % and equal to or less than 10 wt % based on the total weight of the ceria-based composition.

24. The ceria-based composite electrolyte powder according to claim 23, wherein bismuth oxide is present in an amount more than 0 wt % and equal to or less than 5 wt % based on the total weight of the ceria-based composition.

25. The ceria-based composite electrolyte powder according to claim 24, wherein bismuth oxide is present in an amount more than 0 wt % and equal to or less than 3 wt % based on the total weight of the ceria-based composition.

26. The ceria-based composite electrolyte powder according to claim 25, wherein bismuth oxide is present in an amount of 3 wt % based on the total weight of the ceria-based composition.

27. A sintered body of ceria-based composite electrolyte powder which is a calcined body of a ceria-based composition comprising ceria or metal-doped ceria, lithium carbonate, and bismuth oxide, wherein the ceria-based composition comprises more than 0 wt % and equal to or less than 5 wt % of lithium carbonate, and more than 0 wt % and equal to or less than 10 wt % of bismuth oxide.

28. The sintered body according to claim 27, wherein the ceria-based composition comprises more than 0 wt % and equal to or less than 1 wt % of lithium carbonate, and more than 0 wt % and equal to or less than 3 wt % of bismuth oxide.

29. A sintering method comprising:
subjecting a ceria-based composition comprising ceria or metal-doped ceria, lithium carbonate and bismuth oxide to calcination to provide powder, and then sintering the powder, or
sintering the ceria-based composition as it is without calcination,
wherein the ceria-based composition comprises more than 0 wt % and equal to or less than 5 wt % of lithium carbonate, and more than 0 wt % and equal to or less than 10 wt % of bismuth oxide.

30. The sintering method according to claim 29, wherein the powder is subjected to ball milling and then sintered.

31. The sintering method according to claim 29, wherein the powder or composition is charged to a fuel cell without additional sintering, and is sintered during the operation of the fuel cell.

32. The sintering method according to claim 29, wherein said sintering is carried out at a temperature of 800-1000° C.
